(19) United States
(12) Patent Application Publication
(10) Pub. No.: US 2010/0211651 A1
(43) Pub. Date: Aug. 19, 2010

(54) Method and system for multimedia file transfer to a mobile device

(75) Inventors: Isaac David Guedalia, Beit Shemesh (IL); Avri Balofsky, Beit Shemesh (IL); Gabriel Berelejis, Beit Shemesh (IL)

Correspondence Address: Intrinsic Law Corp., 235 Bear Hill Road, Suite 301, Waltham, MA, 02451, US

(73) Assignee: ISKOOT, INC., San Francisco, CA (US)

(21) Appl. No.: 12/657,331

(22) Filed: Jan. 19, 2010

Related U.S. Application Data
(60) Provisional application No. 61/145,551, filed on Jan. 18, 2009.

(51) Int. Cl. G06F 15/16; G06F 21/00

(52) U.S. Cl. 709/217; 709/247; 726/3; 709/246

(57) ABSTRACT

A system and method for providing updates or new multi-media content to mobile devices are discussed. In some embodiments, at least a size of an image file is modified for optimal delivery to and use by a mobile device, therefore conserving bandwidth and device resources.

### RELATED APPLICATIONS

This application incorporates by reference and claims the priority and benefit of U.S. Provisional Patent Application 61/145,551, under 35 U.S.C. Sec. 119(e), filed on Jan. 18, 2009.

### TECHNICAL FIELD

The present application relates to wireless communications for mobile devices, and more specifically to processing and handling of image data for the same.

### BACKGROUND

Present systems provide voice recognition capability, or speech recognition capability, which generally comprise software and associated hardware for detecting human utterances and delivering an output corresponding to said utterances. Specifically, voice recognition has been used to take a spoken input and provide a corresponding written or translated output thereof.

The typical mobile user engages in myriad interactions via a mobile device each and every day. Especially popular today are social networks, which enable registered users to receive updates, including images, of their social contacts. While downloading images for viewing on a mobile device is an exciting and anticipated activity for the mobile user, it may also involve substantial setbacks in the mobile device's performance and resources. Firstly, constant polling to check for new updates and/or images draws significantly on the mobile device's battery power. Secondly, the mobile device's downloading of large images, which it will then resize, takes up significant bandwidth. Both of these drawbacks mean wasted and poorer resources for the mobile device, which translates into a less optimized experience for the mobile user, and added drains on the limited resources of the mobile device and the network. In addition, the heavy data transfer demands of such applications can subject a user account to further bandwidth usage charges.

It is therefore useful to employ more efficient, cost-effective and streamlined systems, applications and methodologies for transferring data, such as image data, between a wireless network and a wireless mobile device.

### SUMMARY

Embodiments hereof are directed to systems and methods for updating, sending, receiving, transferring, processing, and handling data files between wireless networks and mobile communication devices such as cellular phones. In some instances, the transfer of image files from a server in the wireless network to a mobile device is achieved in a streamlined and efficient way that minimizes the use of bandwidth, storage, and processing resources of the server, network and mobile device. More specifically, an optimal format and size for an image file is determined before sending to the mobile device, then the image file is processed, sized, formatted, and sent to the mobile device in an optimal way. This is especially useful in applications where a mobile device user has frequent need or desire to receive an updated image or images from the network, such as is the case in some social networking applications, where users upload and update images and pictures on a regular basis for distribution and sharing with their friends and contacts. Many social networking and similar services are now available on mobile device platforms, making the problem of sharing and updating image files over the wireless network more relevant and acute.

In addition to resizing of the image files prior to transfer to a mobile device, other steps may be employed such as reformatting, compression, encryption, or other file and data processing steps as suited for a particular application.

### BRIEF DESCRIPTION OF THE DRAWINGS

For a fuller understanding of the nature and advantages of the present invention, reference is be made to the following detailed description of preferred embodiments and in connection with the accompanying drawings, in which:

FIG. 1 illustrates an exemplary client-server architecture for providing multimedia files to a mobile device;

FIG. 2 illustrates an exemplary method for providing multimedia files to a mobile device; and

FIG. 3 illustrates another exemplary method for providing multimedia files to a mobile device.

### DETAILED DESCRIPTION

As discussed above, there are several reasons to optimize and pre-process images and similar data files on a server in a wireless communication client-server environment before sending the same to a mobile communication (client) device. One such operation that is discussed below is the resizing of an image file to suit the mobile device's needs and display parameters. The following description illustrates various preferred embodiments of systems and methods for achieving the aforementioned improvements.

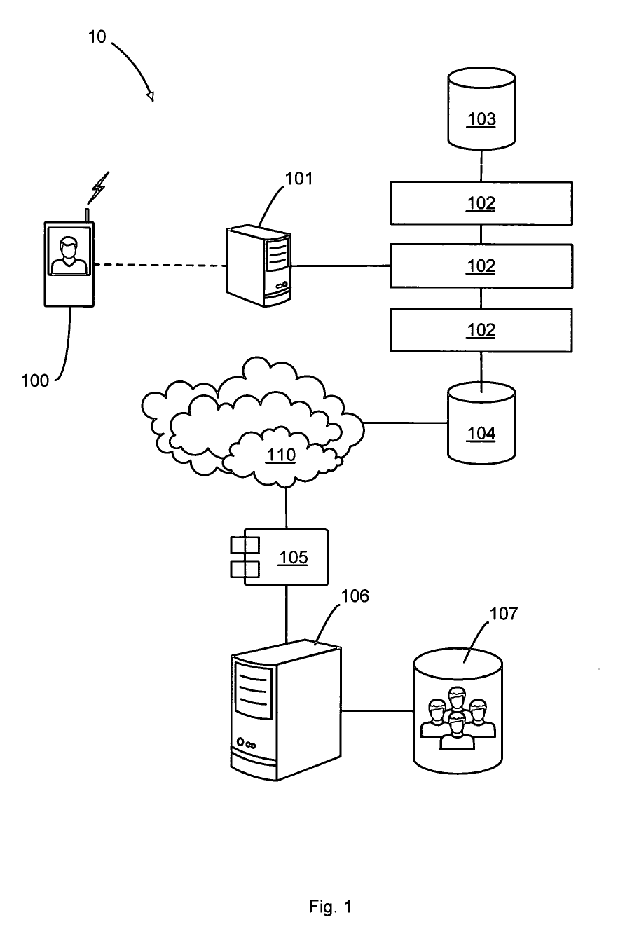

FIG. 1 illustrates an exemplary architecture of a system 10 providing a wireless client-server system that inter alia delivers multimedia files, such as image files, from a stored location 107 to a mobile device 100. The multimedia, e.g., image, files are suitably processed and resized by a server prior to delivery to the mobile device as described herein. It should be understood that image or picture files are but one possible example of the multimedia files the present disclosure is directed to, and that video, audio, or composite audio-video and other types of multimedia files can also benefit from the present techniques and systems.

The mobile communication device 100 is coupled to a proxy server 101, through one or more interfaces, which can include an air interface as well as one or more wired communication paths and media. For example, mobile device 100 comprises a wireless cellular telephone device with a communication processing capability to carry out voice and data communications with a cellular base station. Also, mobile device 100 may include an applications processing capability to run application software, instructions, or programs on the device so as to permit the present access to, reception of, and presentation of multimedia data files to the user of mobile device 100. An operating system may run on the mobile device 100 to enable the device to carry out its multiple functions in a coordinated way, and this may also enable the operator or user of the device to configure the device in a number of ways. For example, the device 100 may be configured for optimal bandwidth savings (to minimize the data usage in the device), or for optimal memory savings (to conserve storage space in the device), or for optimal power consumption (to preserve the battery life of the device), and so on.

In some embodiments, a user of a mobile device 100, registers for a Contact Access Management Service (CAMs) to manage updates from social networking contacts. Examples of such social network services that may provide image file updates include Facebook® or similar services, and the present description is not limited to one type of service, but these are used merely as examples of the usefulness of the present embodiments. Upon signing up for the CAMs service, the user typically downloads and installs a Mobile Application that monitors a Content Provider, such as content from the user's social network service, for updates that may include pictures of or from his or her friends and contacts.

The mobile application may be an application or utility running on a processor of the mobile device 100 to monitor for updates of information relevant to the user of the device. As such, the mobile device 100 may send a request (or periodic requests) over a proxy server 101 to check for updates from a content provider server 106, typically over http. The format of the request may be for example: “http://proxy.iskoot.com/get_me_an_update?imagesize=256”.

It should be noted that the proxy server 110 in this architecture can be a gateway that acts as a proxy for communication for the user to a CAMs data server that is responsible for processing the mobile device's request, such as a Voice Instant Messaging (VIM) server 102. System 10 may include one or more such VIM servers 102 or similar servers for accomplishing the present purpose. In some embodiments, proxy server 101 may deliver information from the mobile device to a VIM 102 and from the VIM 102 to the mobile device 100 without necessarily processing any of the information directly, analogous to a switchboard operator, but this is not necessarily so for all embodiments.

The Proxy server may also be imbued with certain abilities to perform tasks other than just passing on data according to stated instructions given to it by the mobile device. It may, for example, determine the functionality requested by the mobile device and accordingly redirect the client request to a VIM that is more appropriate for that particular functionality.

In some embodiments, the request from the mobile device that is transmitted via the proxy server 110 is sent to the VIM 102, which includes or is coupled to a content poller 104. Generally, a function of the content poller 104 is to poll the content provider server 106 through an application program interface (API) 105 that is provided by the content provider, and to determine if new content updates are available. For example, in a social networking environment, the content poller 104 periodically or on demand would seek updates or information indicative of the availability of updates of multimedia file and other content relevant to a user of mobile device 100. Alternatively, content poller 104 may work in a notification state, in which content provider provides notification to content poller 104 of a change in content, such as an update. Both a ‘push’ and/or a ‘pull’ for update information may be implemented in various embodiments hereof.

From time to time, or continuously as defined for the present system, the content provider API 105 may receive incoming updates for new events which may contain images, intended for an account registered to mobile device 100, the content provider API 105 sends the updates along with the provisioned uniform resource locators (URLs) for the available multimedia files, e.g., images, to the mobile device 100 via the appropriate VIM 102 and proxy server 101.

The mobile device may then request to retrieve the image via the URL it received. This request is typically sent over the Proxy Server to a Resize Script 103 which is hosted by the VIM and it may contain the URL plus the desired image size that the mobile phone has designated, for example: “proxy/vim1/API/images”.

The content poller 104 retrieves the image from an Images cache 107, which is hosted on a service provider (e.g., social networking service provider) content server 106, or coupled thereto. A Formatting Script and/or Resize Script is provided on content provider server 106 where an application will reformat and/or resize the multimedia file. In some embodiments, the content provider server includes a resizing script which can receive an instruction containing an identification of an image file and an indication of a desired image file size for the image, and resizes the identified image to the indicated size. The resized image file (which, again, may apply to other multimedia file types) is delivered to the content poller 104 for sending to VIM 102, the proxy server 101 and on to the mobile device 100. This results in an appropriately formatted and/or sized multimedia (e.g., image) file delivered to mobile device 100 for display on mobile device 100 or enjoyment by its user.

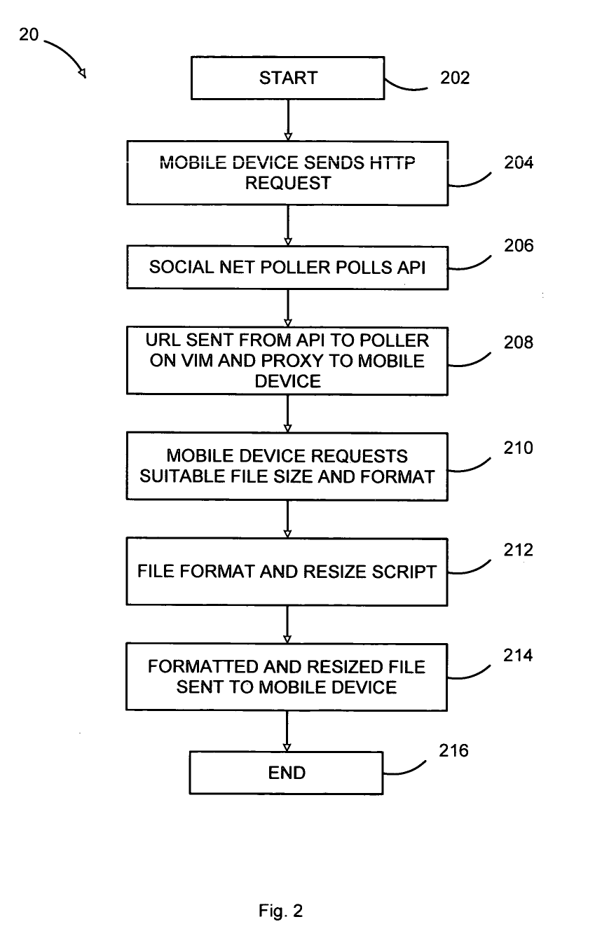

Accordingly, and referring to the exemplary flow chart of FIG. 2, a method 20 for providing reformatted and/or resized multimedia content to a mobile device is described. The method begins at START step 202.

In step 204, a mobile device 100 sends a request for updates to an account of its user, such as a social networking account. The request may include an explicit request for a specific multimedia file (e.g., an image), or the request may indicate a contact of the user of mobile device 100, or the request may just indicate an identity of mobile device 100, its user, or some other identifying information which would allow a system to retrieve updates relevant to the user of mobile device 100. The request is sent out through a proxy server 101 in some embodiments. In some embodiments the request is directed through a VIM server or equivalent instrumentality. The request may further indicate which one of several accounts associated with the user of mobile device 100 is desired for updating, and in further embodiments, may include log-in information or information to permit authentication of the user to the associated account.

In step 206, an appropriate poller on the VIM or coupled thereto polls the content provider API for updates or available multimedia content as requested. Alternatively, the content and updates are pushed to the VIM by the content provider without the need for a request from the user, as mentioned above.

At step 208, a URL or URI corresponding to multimedia (e.g., image) files is sent from the API 105 to the poller 104 on the VIM 102, then to the proxy server 101 and the mobile device 100.

At step 210, mobile device 100 responds to the availability of updates or new multimedia content by requesting said updates or content via its proxy server 101, and by requesting a certain parameter for the multimedia files. In some embodiments, this includes a request for an image file along with an indication of a size of the image file to be delivered to the mobile device 100. More specifically, if mobile device 100 is limited in its bandwidth availability, or its memory storage capacity, or the display screen of the device, it may indicate this limitation in the request for the updated image file so that a larger file is not delivered to the device than is necessary. This saves bandwidth resources, and also memory storage and processing resources at the mobile device. In some embodiments, the multimedia file parameter, such as a size for an image file, is determined by the mobile device 100 or its user.

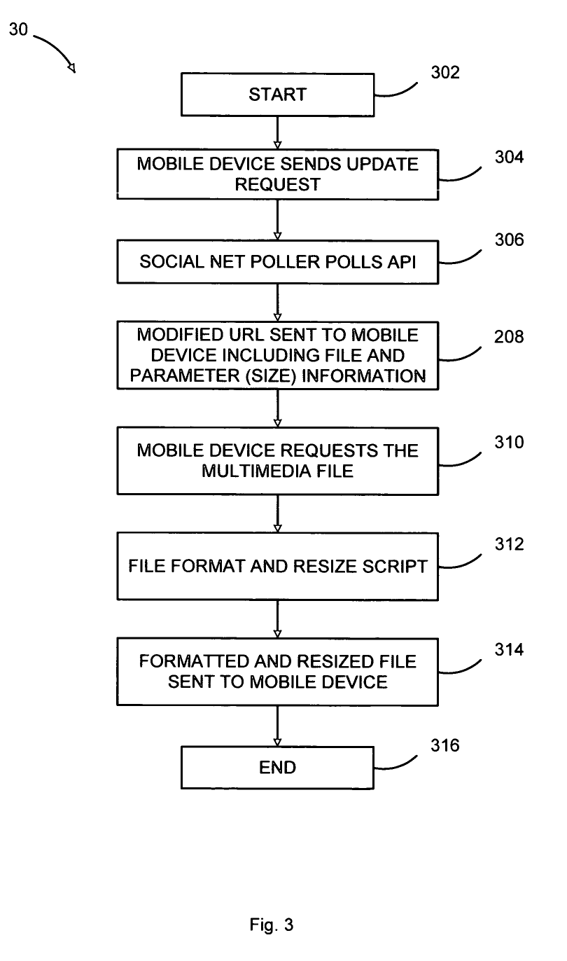

FIG. 3 illustrates another exemplary method 30 for providing multimedia (e.g., image) file data to a mobile device. The method according to some embodiments includes a determination, or estimation, within one or more components of the system of the parameters for a desired multimedia update or files. In some embodiments, the mobile device does not need to inform the system of the value for the desired parameters or properties (e.g., file size) it requires, but the system is adapted to determine this information based on a known property of the mobile device or its user's settings or other account information. That is, sometimes, the system can have information sufficient to determine that for a given mobile device, or a given user, the multimedia files (e.g., images) sent to the device should have certain properties (e.g., file sizes) which are most suited for this device or user.

The method 30 begins at START step 302. After polling the content provider (such as the social networking content provider) API 105, the content poller 104 may return a modified URL to the mobile device, over the VIM 102 and via the proxy server 101. The content and/or updates may also be preemptively pushed by the server 106 as described above.

The modified URL returned by the content poller 104 may consist of an original image file locator or URL along with a resize parameter determined by a resize script 103. Formatting scripts may also be used in some embodiments if the situation calls for a reformatted file.

When the mobile device 100 requests the file or image which the modified URL points to, the resize request may be performed by the Resize Script on the VIM after which the resized image would be sent to the mobile device for the user to view.

The present invention should not be considered limited to the particular embodiments described above, but rather should be understood to cover all aspects of the invention as fairly set out in the attached claims. Various modifications, equivalent processes, as well as numerous structures to which the present invention may be applicable, will be readily apparent to those skilled in the art to which the present invention is directed upon review of the present disclosure. The claims are intended to cover such modifications.

What is claimed is:

1. A method for delivering multi-media content to a mobile device, comprising:
providing a communication connection between a mobile device and a communication network;
receiving an update request from said mobile device requesting updates of at least one multi-media file from said network;
receiving from said mobile device, an identification of a multi-media file to be delivered to said mobile device from said network;
receiving from said device, an indication of at least one property for said multi-media file as requested by said mobile device, based on at least one corresponding parameter of said mobile device or account of a user of said mobile device; and
modifying the identified multi-media file in at least one respect, according to the indicated at least one property indicated by said mobile device prior to delivering said multi-media file to said mobile device.

2. The method of claim 1, said at least one property including a file size for said multi-media file and said modifying including re-sizing said multi-media file to conform to said file size.

3. The method of claim 1, said at least one property including a file format for said multi-media file and said modifying including re-formatting said multi-media file to conform to said file format.

4. The method of claim 1, said at least one property including a file size and including a file format for said multi-media file.

5. The method of claim 1, further comprising determining an optimal file size for presentation to a user of said mobile device.

6. The method of claim 1, further comprising receiving authentication information from said mobile device to permit retrieval of said indicated multi-media file from a file server.

7. The method of claim 1, further comprising polling a content provider for updates to said multi-media file or an account associated with said multi-media file.

8. The method of claim 1, further comprising receiving a notification from a content provider indicating updates to said multi-media file or updates to information associated with said multi-media file.

9. The method of claim 1, wherein delivering said multi-media content to said mobile device comprises delivering image file content to said mobile device.

10. The method of claim 1, wherein delivering said multi-media content to said mobile device comprises delivering sound file content to said mobile device.

11. The method of claim 1, wherein delivering said multi-media content to said mobile device comprises delivering both image and sound content to said mobile device.

12. A system for delivering multi-media content from a network to a mobile device, comprising:
a server adapted and arranged to receive information from and provide information to a mobile device over a communication network;
a polling module for making requests for updates to a content provider;
an application program interface for exchanging content between said server and said content provider; and
a resizing module for modifying a file size of a multi-media file to be delivered to said mobile device according to a file size suited for use by said mobile device.

13. The system of claim 12, further comprising a formatting module for modifying a file format of a multi-media file to be delivered to said mobile device according to a file format suited for use by said mobile device.

14. The system of claim 12, further comprising a proxy server module for permitting communication between said mobile device and said network.

15. A method for delivering multi-media content to a mobile device, comprising:
providing a communication connection between a mobile device and a communication network;
receiving an update request requesting updates of at least one multi-media file from said network;
receiving an identification of a multi-media file to be delivered to said mobile device from said network;
determining at least one property for said multi-media file based on at least one corresponding parameter of said mobile device or account of a user of said mobile device, said at least one property including a file size of said multi-media file; and
modifying the identified multi-media file in at least one respect, according to the indicated at least one property; and
delivering said modified multi-media file to said mobile device.

16. The method of claim 15, said receiving of said identification of said multi-media file includes receiving, from said mobile device, the identification of said multi-media file.

17. The method of claim 15, said receiving of said identification of said multi-media file includes receiving, from a content provider, the identification of said multi-media file.

18. The method of claim 15, said determining of said property comprising receiving a property parameter from said mobile device.

19. The method of claim 15, said determining of said property comprising computing a property parameter based on known properties of said mobile device or an account associated with said mobile device.
